(19) United States
(12) Patent Application Publication
(10) Pub. No.: US 2007/0102240 A1
(43) Pub. Date: May 10, 2007

(54) Bail out device

(76) Inventor: Jonathan L. Wilson, Poughkeepsie, NY (US)

Correspondence Address: JOHN MAIER, III, 660 AARON COURT, KINGSTON, NY, 12401, US

(21) Appl. No.: 11/271,615

(22) Filed: Nov. 10, 2005

(51) Int. Cl. A47L 3/04; E06C 7/18

(52) U.S. Cl. 182/5

(57) ABSTRACT

A bail out device for rapidly escaping from an unsafe structure is provided. A rope has an attachment section and a repelling section. The attachment section is connected to the repelling section. The repelling section is substantially longer than the attachment section. An attachment means is connected to one end of the attachment section. The attachment section has a double figure eight knot adjacent to the attachment means. A fire resistant sheath covers the attachment section. A descending device which is a plate with five openings in it. The rope in the repelling section extends in and out of four of the five openings. An intermediate clip is mounted in one of the openings of the descending device. A leash, which is a sewn quick draw sling, connects an outer clip to the intermediate clip.

### BACKGROUND OF THE INVENTION

1. Field of the Invention

This invention relates to bail out devices and, more specifically, to a bail out device for use by a firefighter to permit repelling from a dangerous situation.

2. Prior Art

It is well known that fire fighters, upon entering a burning structure, face the possibility of their situation turning increasingly unsafe. A rope can be carried to repel from the structure should the situation warrant bailing out. However, securing the rope takes time and time is often not available. A firefighter needs a device for bailing out which is worn on the firefighter's protective gear and that can be quickly implemented with dependability.

3. Objects

The objects of the device are to provide a bail out device as follows:

1. That can be readily used by a fire fighter in an emergency.

2. That can be worn by the firefighter on the protective gear of the fire fighter.

3. That can be very quickly deployed by a fire fighter.

4. That is comparatively safe and dependable.

5. That is economical.

Further objects of the invention will appear as the description proceeds.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the attached claims.

### SUMMARY OF THE INVENTION

A bail out device is provided for rapidly escaping from an unsafe structure. A rope which has an attachment section is and a repelling section is utilized. The attachment section is connected to the repelling section. The repelling section is substantially longer than the attachment section. Attachment means are connected to the attachment section for securing the attachment section to the structure. A descending device, which is a plate with five openings in it is located on the repelling section of the rope. The repelling section extends in and out of four of the five openings of the descending device. An intermediate clip is attached to the descending device and a leash is connected to the intermediate clip. An inner clip attached to the leash.

### DESCRIPTION OF THE FIGURES

FIG. 1 is a pictorial view showing the bail out device mounted on a harness on the torso of a firefighter with the attachment section in the front of the firefighter.

FIG. 2 plan view of the bail out device with the bag for holding the repelling section broken open to show the knot in th end of the repelling section.

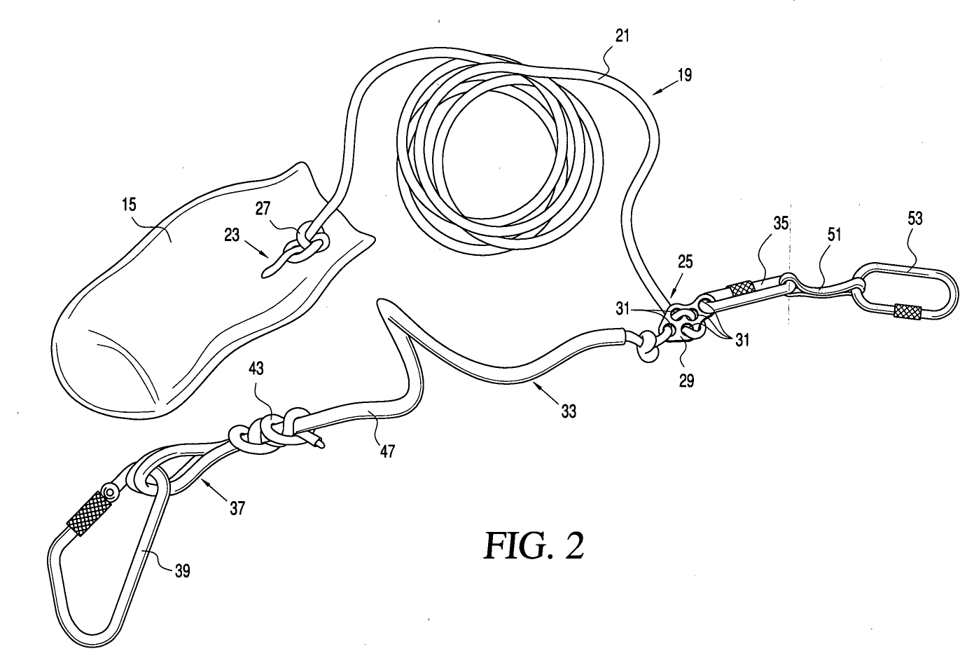

FIG. 3 is a pictorial view of a firefighter with the bail out device on the protective gear of the firefighter and with the attachment section extending from the firefighter for attachment to any suitable point in a structure.

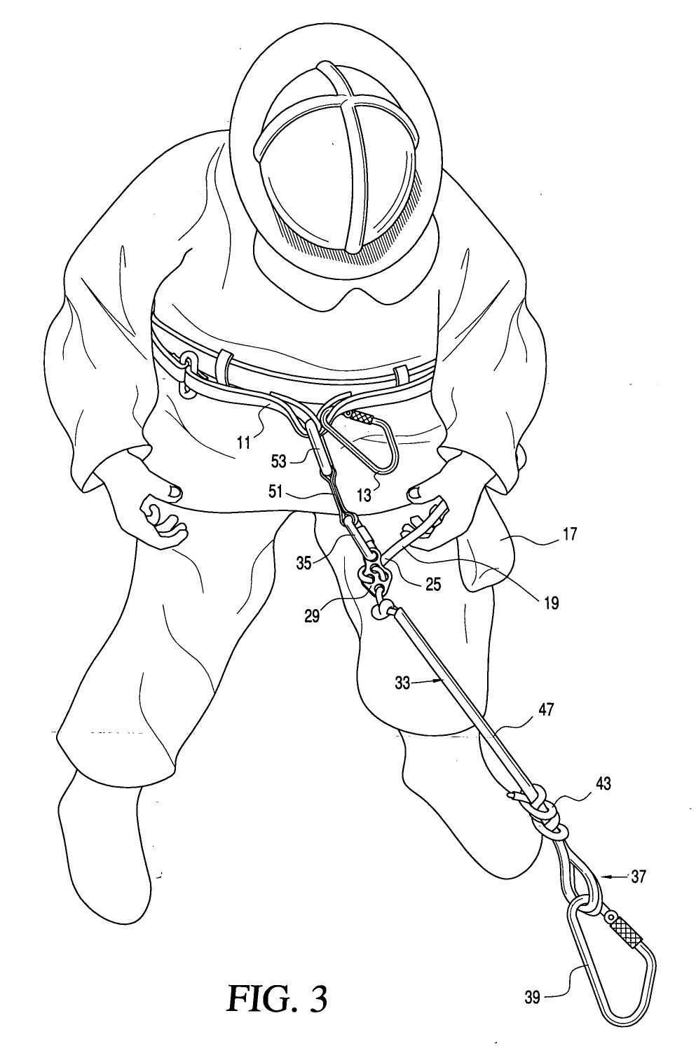

### BRIEF DESCRIPTION OF THE NUMERALS

| NUMERAL | DESCRIPTION |
|---|---|
| 11 | Harness |
| 13 | Large D Clip |
| 15 | Bag |
| 17 | Side Pocket |
| 19 | Repelling Section |
| 21 | Rope |
| 23 | Outer End |
| 25 | Inner End |
| 27 | Knot |
| 29 | Descending Device |
| 31 | Openings |
| 33 | Attachment Section |
| 35 | Intermediate Clip |
| 37 | Outer End |
| 39 | Retainer Clip |
| 43 | Double Figure Eight Knot |
| 47 | Sheath |
| 51 | Leash |
| 53 | Outer Clip |

### DETAILED DESCRIPTION OF THE PREFERRED EMBODIMENT

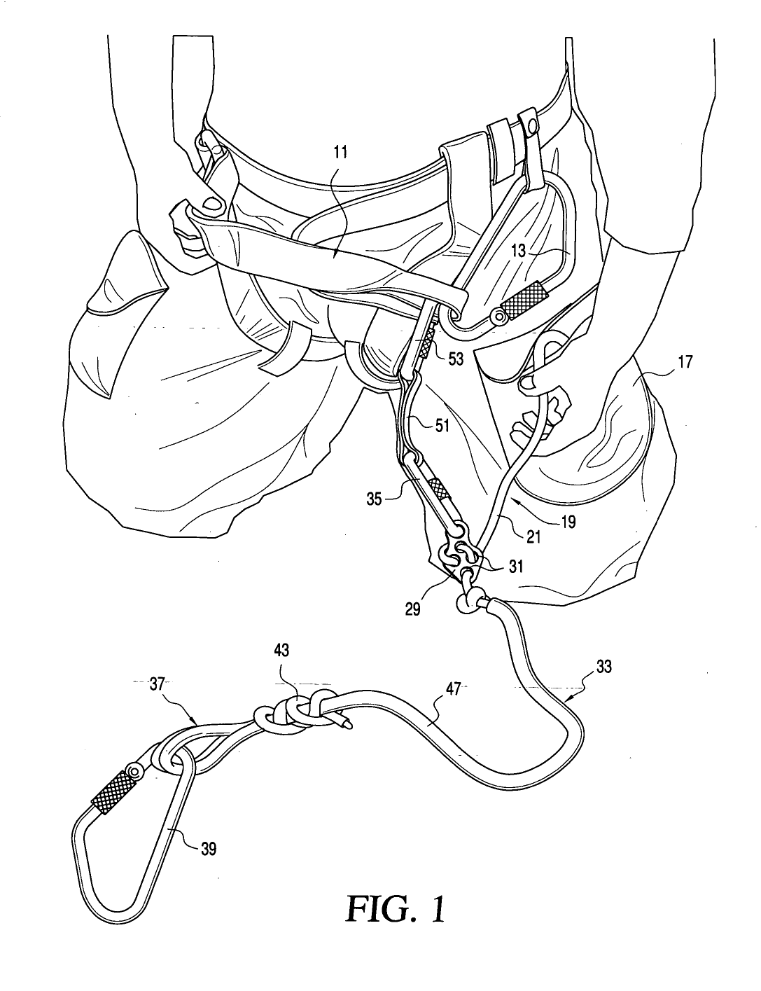

Referring now to FIG. 1, a torso of a firefighter is shown. The firefighter is wearing a harness 11 which includes a large D clip 13. The bailout device is secured to the harness 11. A bag 15 is located in a side pocket 17 of the firefighter and a repelling section 19 of the rope 21 is coiled within the bag 15. The length of the repelling section 19 of the bail out device is generally about thirty six feet to provide an adequate length of rope 21 to reach or approach the ground from a dwelling and, even in a high rise situation, at least to provide sufficient rope to repel to a lower level of a building to safety. The repelling section 19 would have a length of at least thirty feet and usually no more than forty feet to provide an adequate distance to reach safety and still not have an excessive amount of rope 21 to carry.

The repelling section 19 has an outer end 23 and an inner end 25. The outer end 23 of the rope 21 is the end which Is farthest from the point of bail out. A knot 27 is tied at the outer end 23 of the repelling section 19 to provide a warning to a firefighter descending the rope 21 that there is no more rope 21 available. This is intended to prevent a firefighter from falling unexpectedly from the rope 21.

A descending device¹ 29 is located on the repelling section 19 of the rope 21. The descending device 29 provides a controlled descent down the rope 21. The descending device 29 is a plate with five openings 31 through it. The repelling section 19 of the rope 21 passes through four of the openings 31 in the descending device 29 to control descent without stopping descent.
¹The descending device is a product of Pigeon Mountain Industries.

The repelling section 19 of the rope 21 is one of two sections for the bail out device. The other section of the rope 21 is the attachment section 23 which extends from an intermediate clip 35 which is secured to the descending device 29 by use of the one remaining opening 31 in the descending device 29 not occupied by the repelling section 19 of the bail out device. At the outer end 37 of the attachment section 33 of the bail out device is a retainer clip or attachment means 39, which is preferably an extra large D clip. A double figure eight knot 43 is placed in the rope 21 adjacent to the retainer clip 39. The retainer clip 39 is designed to be secured to anything available near the escape point such as a radiator or even an axe forced into a wooden structural member. The double figure eight knot 43 serves as a hand grip to hold the firefighter during the initial departure from the structure. The rope 21 in the attachment section 33 is entirely covered by a sheath 47 which is also fire resistant. The double figure eight knot is tied after the rope 21 is covered by the sheath 47 The sheath 47 also provides additional gripping ability for the firefighter while the firefighter moves toward the repelling section 19 of the rope 21. The repelling section 19 is substantially longer than the attachment section 33.

The opening 31 in the descending device 29 which is not occupied by the rope 21 is connected to the intermediate clip 35 which is preferably a locking carabineer. A leash 51, which is a sewn quick draw string, connects the intermediate clip 35 to an outer clip 53 which is also an outer locking carabineer. The outer clip 53 is connected to the harness 11 worn by the firefighter.

The leash 51 and the outer clip 53 retain the bail out device on the firefighter prior to use by the firefighter and during use of the bail out device. When the firefighter reaches the descending device 29 at the end of the sheath 47, the firefighter descends down the repelling section 19 of the rope 21 on the descending device 29.

It is to be understood that the drawings and description matter are in all cases to be interpreted as merely illustrative of the principles of the invention, rather than as limiting the same in any way, since it is contemplated that various elements exist to achieve like results without departing from the spirit of the invention or the scope of the appended claims.

1. A bail out device for rapidly escaping from an unsafe structure comprising:
a rope having an attachment section and a repelling section, the attachment section being connected to the repelling section, the repelling section being substantially longer than the attachment section;
attachment means connected to the attachment section for securing the attachment section to the structure;
a descending device, the repelling section of the rope extending in and out of four of the five openings of the descending device;
an intermediate clip attached to the descending device;
a leash connected to the intermediate clip; and
an outer clip attached to the leash.

2. A bail out device according to claim 1 wherein the repelling section has an outer end and an inner end and the attachment section has an inner end and an outer end, the inner end of the repelling section being connected to the inner end of the attachment section.

3. A bail out device according to claim 1 wherein the repelling section has an outer end and an inner end and the attachment section has an inner end and an outer end, the inner end of the repelling section being connected to the inner end of the attachment section and the repelling section has a knot located at the outer end of the repelling section.

4. A bail out device according to claim 1 wherein the attachment means connected to the attachment section is an extra large D clip.

5. A bail out device according to claim 1 wherein the attachment section has a double figure eight knot adjacent to the attachment means.

6. A bail out device according to claim 1 wherein the attachment means connected to the attachment section is an extra large D clip; and
wherein the rope has a double figure eight knot adjacent to the attachment means.

7. A bail out device according to claim 1 further including a fire resistant sheath partially covering the attachment section.

8. A bail out device according to claim 1 wherein the descending device is a plate with five openings in it, the repelling section of the rope extending in and out of four of the five openings.

9. A bail out device according to claim 1 wherein the leash is a sewn quick draw sling.

10. A bail out device according to claim 1 wherein the repelling section has an outer end and an inner end and the attachment section has an inner end and an outer end, the inner end of the repelling section being connected to the inner end of the attachment section, the repelling section having a length in the range of thirty to forty feet.

11. A bail out device for rapidly escaping from an unsafe structure comprising:
a rope having an attachment section and a repelling section, the attachment section being connected to the repelling section, the repelling section being substantially longer than the attachment section;
an attachment means connected to one end of the attachment section, the attachment section having a double figure eight knot adjacent to the attachment means;
a fire resistant sheath on the attachment section;
a descending device being a plate with five openings in it, the repelling section extending in and out of four of the five openings, an intermediate clip mounted in one of the openings of the descending device;
an outer clip; and
a leash being a sewn quick draw sling connecting the outer clip to the intermediate clip.

12. A bail out device according to claim 11 wherein the inner end of the repelling section is connected to the inner end of the attachment section and has a knot located at the outer end of the repelling section.

13. A bail out device according to claim 11 wherein the attachment means connected to the attachment section is an extra large D clip.

14. A bail out device for rapidly escaping from an unsafe structure comprising:
a rope having an attachment section and a repelling section, the the repelling section having an outer end and an inner end and the attachment section having an inner end and an outer end, the inner end of the repelling section bing connected to the inner end of the attachment section;
an extra large D-clip connected to the outer end of the attachment section; the rope having a double figure eight knot adjacent to the extra large locking D-clip;
a fire resistant sheath covering the attachment section;
a descending device being a plate with five openings in it, the repelling section of the rope extending in and out of four of the five openings, an intermediate clip being a locking carabineer mounted in an opening in the descending device, the repelling section of the rope from the inner end of the repelling section approximately for a length in the range of thirty to forty feet, a knot being located at the outer end of the repelling section;
an outer clip being a locking carabineer; and
a leash being a sewn quick draw sling connecting the outer clip to the intermediate clip.
